(19) United States
(12) Patent Application Publication
(10) Pub. No.: US 2026/0285755 A1
(43) Pub. Date: Sep. 24, 2026

(54) USE OF A MARL FOR THE PREPARATION OF A POZZOLANIC MATERIAL

(71) Applicant: VICAT, L'Isle-D'Abeau (FR)

(72) Inventors: François AVET, Saint Alban de Roche (FR); Hichem KROUR, Bron (FR); Camille CHEREAU, Villeurbanne (FR); Laure DELAVERNHE, Voiron (FR)

(73) Assignee: VICAT, L'Isle-D'Abeau (FR)

(21) Appl. No.: 19/471,789

(22) PCT Filed: Apr. 5, 2024
(86) PCT No.: PCT/FR2024/050444

§ 371 Date: Oct. 2, 2025

(30) Foreign Application Priority Data
Apr. 7, 2023 (FR) FR2303489

(51) Int. Cl. C04B 20/04; C04B 7/12; C04B 14/06; C04B 14/10; C04B 14/28; C04B 20/02

(52) U.S. Cl. CPC C04B 20/04; C04B 7/12; C04B 14/06; C04B 14/104; C04B 14/106; C04B 14/28; C04B 20/026

(57) ABSTRACT

The present invention relates to the use of a marl comprising:
more than 45% (w/w) of calcite; and
at least 1% (w/w) of kaolinite;
for the preparation of a pozzolanic material by the calcination of said marl at a temperature ranging from 400° C. to 950° C.

The present invention relates to the use of a marl for the preparation of a pozzolanic material.

The manufacture of hydraulic binders, and in particular that of cements, essentially consists in calcining a mixture of carefully selected and dosed raw materials, also refereed to by the term “raw-mix”. The firing of this raw-mix gives an intermediate product, the clinker, which, crushed with possible mineral additions, will give cement. The type of manufactured cement depends on the nature and proportions of the raw materials as well as the firing process. There are several types of cement: Portland cements (which represent the vast majority of cements produced in the world), aluminous (or calcium aluminate) cements, natural quick setting cements, sulfo-aluminous cements, sulfo-belitic cements and other intermediate varieties.

The most common cements are Portland cements. Portland cements are obtained from Portland clinker, obtained after clinkering at a temperature in the range of 1450° C. of a raw-mix rich in calcium carbonate in a kiln. The production of one ton of Portland cement is accompanied by the emission of very large amounts of CO₂ (approximately 0.8 to 0.9 tons of CO₂ per ton of cement in the case of a CEM I).

Yet, in 2019, the amount of cement sold around the world was around 4.1 billion tons (source: French Cement Industry Association—SFIC). This figure, which is constantly increasing, has more than doubled in 15 years. The cement industry is therefore today looking for a valid alternative to Portland cement, that is to say cements having at least the same strength and quality features as Portland cements, but which, during their production, release less CO₂.

During the production of clinker, the main constituent of Portland cement, the release of CO₂ is linked to:
approximately 40% from the heating of the cement kiln, crushing and transportation;
approximately 60% from so-called chemical or decarbonation CO₂.

The decarbonation is a chemical reaction that takes place when limestone, the main raw material for manufacturing Portland cement, is heated at high temperatures. The limestone is then transformed into quick lime and CO₂ according the following chemical reaction:

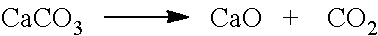

To reduce the CO₂ emissions linked to the production of Portland cement, several approaches have been considered so far:
adapting or modernizing cement manufacturing processes in order to maximize the efficiency of the thermal exchanges;
developing new “low carbon” binders such as sulfo-aluminous cements prepared from raw materials less rich in limestone and at a lower firing temperature, which enables a reduction in CO₂ emissions of around 35%;
or even more (partial) substituting clinker in cements by materials allowing to limit CO₂ emissions.

Among the above approaches, that of the (partial) substitution of clinker in cements has been the subject of many developments. Two ways were mainly explored: the substitution of clinker by limestone filler and the substitution of clinker by so-called “pozzolanic” materials.

The substitution of clinker by limestone filler is limited due to its low chemical reactivity. Such a substitution therefore results in a dilution effect which is accompanied by a significant drop in strength for high levels of substitution.

On the other hand, the substitution of clinker by active or “pozzolanic” materials is accompanied by a much smaller reduction in strength and for some of them by an increase in strength.

A pozzolanic material generally designates any material having “pozzolanic properties”, that is to say capable of combining at room temperature and in the presence of water with lime or Portlandite formed during the hydration of the cement to give hydrates with very little solubility likely to generate additional strength in the long term.

Portland cement is in fact mainly constituted by two types of anhydrous phases: calcium silicates (C₃S and C₂S—in which C represents CaO and S represents SiO₂) and calcium aluminates (C₂A and C₄AF—in which C represents CaO, A represents Al₂O₃ and F represents Fe₂O₃). It also contains free lime in small amounts.

It is the hydration of the silicate phases which generates the strength through the formation of hydrates of the gel type: hydrated calcium silicates C—S—H according to the following equations (unbalanced):

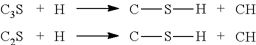

in which C represents CaO, S represents SiO₂ and H represents H₂O.

Portlandite “CH” is a co-product of the hydration of calcium silicates. It represents between 15 and 20% by weight of completely hydrated cement in the case of CEM I.

The pozzolanic material is a source of amorphous and highly reactive silica and/or alumina. When mixed with cement, it will react with portlandite to form new hydrates:

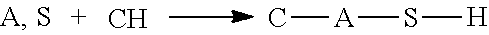

in which A represents Al₂O₃, C represents CaO, S represents SiO₂ and H represents H₂O.

The pozzolanic reaction, slower and later, therefore enables the consumption of portlandite to form secondary or late C—S—H, generally richer in alumina than the C—S—H derived from silicates; generally noted C-A-S—H for this reason. Like C—S—H, C-A-S—H are barely crystallized, or not at all, hydrates which close the porosity and generate an increase in strength in the longer term.

At the date of the present invention, different pozzolanic materials are used:
the so-called “natural” pozzolans which are volcanic rocks rich in naturally amorphous silica and alumina;
fly ash derived from the production of electricity in coal-fired power plants and essentially consisting by silica, alumina and iron oxide;
silica smoke originating from the reduction of quartz by carbon during the production of silicon and iron/silicon alloys;
blast furnace slag, obtained in the steel industry during the production of cast iron, almost entirely amorphous, consisting by silica, alumina but also calcium and magnesium oxide; and
calcined clays which are synthetic pozzolans obtained by the calcination at temperatures ranging from 600° C. to 900° C. of clays, in particular of kaolinitic, illitic or montmorillonitic clays.

Nevertheless, the pozzolanicity of these materials remains variable, and the strength of construction materials prepared from pozzolanic materials is sometimes significantly lower than that of construction materials prepared from conventional Portland cements. It therefore remains interesting to identify new pozzolanic materials enabling the preparation of construction materials having a strength in the medium and long term comparable to that of construction materials prepared from Portland cements, while significantly limiting CO₂ emissions during their preparation.

At the time of the present invention, the use of clays for the preparation of synthetic pozzolan by calcination is probably the strategy for reducing the carbon footprint of cements and concretes with the greatest potential. However, the use of large quantities of clay will pose problems of availability of the raw material.

Alternative solutions have thus been studied, such as the use of marl for the preparation of synthetic pozzolan by calcination.

Marl is a sedimentary rock, mainly composed of a mixture of calcite (CaCO₃) and clay.

In their publication “Microstructure and mineral composition of Roman cements produced at defined calcination conditions”, Materials Characterization, 58, 2007, pages 1217-1228, J. Weber et al. study in particular the pozzolanic properties of calcined marls. The studied marls contain respectively 71% and 63% by weight of calcite and are free of kaolinite. The authors note that while the (very) long-term strengths obtained with these calcined marls are satisfactory, the short-term or medium-term strengths are insufficient.

Similarly, in their publication “Calcareous smectite clay as a pozzolanic alternative to kaolin”, European Journal of Environmental and Civil Engineering, 2019, D. Tanner et al. also study the pozzolanic properties of calcined marls. The first studied marl contains 47% by weight of kaolinite and is free of calcite. The second studied marl comprises 8% by weight of kaolinite and 25% of calcite. Beyond 20% substitution of Portland cement by these calcined marls, the observed short-term strengths for the construction material thus prepared appear insufficient.

To aim for a strong substitution of cements, particularly Portland, by the pozzolans in the construction materials, and consequently obtain a substantial environmental impact, it is therefore still necessary to identify materials likely to be used for the preparation of pozzolanic materials which can themselves be used in high proportions in the construction materials while maintaining mechanical properties, and in particular short-term strengths compatible with the implementation and the use of said construction material.

Chinese patent application CN 102 674 722 describes the use of a marl containing 85% by weight of CaCO₃ and 15% of white clay calcined between 1000° C. and 1400° C. as a cementitious material that can be used to reinforce the ruins of an earthen building. In addition to the fact that the calcined marl is not used as a pozzolanic material but as a building material in its own right, the calcination temperature of the marl does not differ sufficiently from the clinkerization temperature of Portland cements to significantly limit the quantities of CO₂ emitted during the production of this material.

Now, it has now been found, quite surprisingly, that calcite-rich marls comprising kaolinite can, once calcined at temperatures below 1000° C., be used as a pozzolanic material in construction materials, and this in significant proportions, up to 50% by weight or even more of the construction material while maintaining a short-term strength of the construction material thus prepared compatible with its use. The 10 construction materials thus prepared further have medium and long-term strengths comparable to those of the construction materials prepared from conventional Portland cements, and can be prepared while significantly limiting CO₂ emissions.

Thus, the present invention relates to the use of a marl comprising:
15-more than 45% (w/w) of calcite; and
at least 1% (w/w) of kaolinite;
for the preparation of a pozzolanic material by the calcination of said marl at a temperature ranging from 400° C. to 950° C.

Surprisingly, marls with high calcite contents and containing kaolinite can, once calcined, be used as pozzolanic material in construction materials, in proportions of up to 25% by weight or even 50% by weight of the construction material while maintaining a short-term strength of the construction material thus prepared compatible with its use. The construction materials thus prepared further have medium and long-term strengths comparable to those of the construction materials prepared from conventional Portland cements, and can be prepared while significantly limiting CO₂ emissions.

In the context of the present invention:
“calcite” means a polymorph of calcium carbonate CaCO₃;
“kaolinite” means the mineral of the phylosilicate family with the formula Al₂Si₂O₅(OH)₄;
“marl” means any sedimentary rock composed mainly of polymorphs of calcium carbonate and/or magnesium carbonate, and clay phases, in particular kaolinite, illite and/or montmorillonite phases;
“montmorillonite” means the mineral of the phylosilicate family with the formula (Na, Ca)_{0.3}(Al,Mg)₂Si₄O₁₀(OH)₂·nH₂O;
“illite” means the mineral of the phyllosilicate family of type 2:1 with potassium as an interfoliar cation, also including muscovite-type micas, with the formula (K,H₃O) (Al,Mg,Fe)₂(Si,Al)₄O₁₀;
“pozzolanic material” means any material with pozzolanic properties within the meaning of European standard NF EN 197-1, that is to say capable of combining at room temperature and in the presence of water with lime or Portlandite formed during the hydration of cement to give very slightly soluble hydrates likely to generate additional long-term strength; and
“construction material” means cement, concrete, mortar.

In the context of the present invention, the median diameter or d50 corresponds to the diameter below which 50% of the total volume of the particles of the considered sample is found. This may be determined by any method known to those skilled in the art, in particular by laser granulometry in dry or wet route.

Finally, in the context of the present invention, the proportions expressed in % correspond to weight percentages with respect to the total weight of the considered entity (w/w).

The present invention therefore relates to the use of a marl having the mineralogical characteristics described above for the preparation of a pozzolanic material by the calcination of said marl at a temperature ranging from 400° C. to 950° C. Preferably, the present invention relates to the use of a marl as previously defined for the preparation of a pozzolanic material, said marl having the following characteristics, chosen alone or in combination:
the marl contains at least 50% (w/w) of calcite, more preferably the marl contains at least 55% (w/w) of calcite, most preferably the marl contains at least 60% (w/w) of calcite;
the marl contains at least 1.5% (w/w) of kaolinite, more preferably the marl contains at least 2% (w/w) of kaolinite, most preferably the marl contains at least 2.5% (w/w) of kaolinite;
the marl further contains montmorillonite, more preferably the marl contains at least 3% (w/w) of montmorillonite, most preferably the marl contains at least 5% (w/w) of montmorillonite;
the marl further contains illite, more preferably the marl contains at least 3% (w/w) of illite, most preferably the marl contains at least 5% (w/w) of illite;
the marl further contains quartz, more preferably the marl contains at least 3% (w/w) of quartz, most preferably the marl contains at least 7% (w/w) of quartz;
the marl also contains chlorite, dolomite, microcline, albite, ankerite, orthoclase, pyrite, siderite, anatase and/or celestine; and/or
the calcination of the marl is carried out at a temperature ranging from 500° C. to 900° C., more preferably at a temperature ranging from 650° C. to 900° C., most preferably at a temperature ranging from 650° C. to 800° C.

The marl described above can therefore be used to prepare a pozzolanic material by calcination. Thus, the present invention also relates to a process or preparing a pozzolanic material from the marl previously described by the calcination of said marl at a temperature ranging from 400° C. to 950° C., preferably from 500° C. to 900° C., more preferably from 650° C. to 900° C., most preferably from 650° C. to 800° C. Preferably, the process according to the present invention comprises the following steps:
drying and/or crushing the marl;
calcining the obtained material at a temperature ranging from 400° C. to 950° C., preferably from 500° C. to 900° C., more preferably from 650° C. to 900° C., most preferably from 650° C. to 800° C.; and
optionally disaggregating the obtained calcined marl, for example by crushing, until reaching a median diameter of 5 μm to 20 μm.

During the possible crushing of the marl before calcination, this is preferably performed with a view to obtaining a powder with 100% undersize at 2 mm.

The calcination step can be carried out using a rotary calciner, within which it lasts approximately 30 to 90 minutes. However, a “flash calciner” can also be used to calcine marl with a view to obtaining a pozzolanic material, in which case the calcination step is very brief (1 to 2 seconds or less). The fact that a flash calciner can be used makes it possible to significantly reduce the energy required for calcination and preparation of the pozzolanic material.

When the calcined marl is possibly crushed, this is performed until reaching a median diameter less than or equal to 25 μm, preferably less than or equal to 20 μm, and most preferably less than or equal to 15 μm.

The present invention may be illustrated in a non-limiting manner by the following examples.

### EXAMPLE 1—CALCINATION OF THE MARL

### 1.1—Composition of the Marl

A raw marl having the mineralogical composition reported in the following Table 1 is used.

TABLE 1
Mineralogical composition of the marl before calcination

| Phase | % (w/w) |
|---|---|
| Albite | 0.5 |
| Ankerite | 1.6 |
| Calcite | 60.1 |
| Chlorite | 1.8 |
| Dolomite | 0.8 |
| Kaolinite | 2.8 |
| Microcline | 2.6 |
| Montmorillonite | 8.5 |
| Illite | 8.1 |
| Orthoclase | 1. |
| Pyrite | 0.6 |
| Quartz | 10.8 |
| Siderite | 0.4 |
| Anatase | 0.3 |
| Celestine | 0.5 |

The above marl has the chemical composition (in % (w/w)) reported in the following Table 2.

TABLE 2
Chemical composition of the marl before calcination

| | |
|---|---|
| Al₂O₃ | 7.6 |
| CaO | 30.5 |
| Cl | 0.01 |
| Fe₂O₃ | 3. |
| K₂O | 2.3 |
| MgO | 2. |
| MnO | 0.05 |
| Na₂O | 0.1 |
| P₂O₅ | 0.1 |
| SiO₂ | 24.3 |
| SO₃ | 0.4 |
| SrO | 0.1 |
| TiO₂ | 0.4 |
| Sulfides | 0.3 |
| Loss on ignition | 28.6 |
| at 950° C. | |

### 1.2—Calcination of the Marl

The marl described above is dried for 12 hours at 105° C. and then crushed in a ring mill to a median diameter of 30 to 40 μm. The powder thus prepared is fired in a laboratory kiln in 200 g batches at 750° C. for 1 hour with hot loading and unloading. The calcined marl thus obtained (calcined marl AC-1) is then lightly crushed again in a planetary mill (15 seconds, 700 rpm) to deagglomerate it and obtain a median diameter of 20 μm.

### 1.3-Mineralogical Composition

The calcined marl thus obtained is analyzed. Its mineralogical composition (in % (w/w)) is reported in the following Table 3.

TABLE 3
Mineralogical composition of a calcined marl AC-1

| Phase | AC-1 |
|---|---|
| Periclase | 1.5 |
| Quartz | 15.0 |
| Anhydrite | 1.0 |
| Calcite | 23.2 |
| Gehlenite | 0.1 |
| Microcline | 1.3 |
| Orthoclase | 1.0 |
| Illite | 6.6 |
| Hematite | 0.8 |
| Bredigite | 1.4 |
| Amorphous | 45.6 |

### EXAMPLE 2—MORTAR COMPOSITION ACCORDING TO THE INVENTION

### Preparation

A reference mortar (hereinafter Mortar 1) is prepared from Portland cement CEM I 52.5 R according to standard EN 196-1. The composition of mortar 1 is as follows:
450 g of CEM I 52.5 R cement;
1350 g of standardized sand; and
225 g of water.

Similarly, mortars 2 to 4 are respectively prepared from a mixture:
88% of CEM I 52.5 R/12% of limestone filler (mortar 2);
79% of CEM I 52.5 R/21% of limestone filler (mortar 3); and
CEM I 52.5 R/15% of limestone filler/30% of AC-1 (mortar 4).

### Mechanical Strength

The mechanical strength of the mortars is measured in accordance with standard EN 196-1 on prismatic mortar test specimens 4×4×16 cm3 prepared at 20° C.

The performance index characterizes the performance of the pozzolanic material when used at x % substitution. It is defined as the ratio of the compressive strengths (measured as indicated above) of a cement mortar constituted by 100-x % of a reference cement and x % of the considered pozzolanic addition, and of a mortar prepared with 100% of reference cement.

$$IP ( \% ) = \frac{RC cement substituted at x \%}{RC Reference}$$

The results of the compressive strength (Rc) measurements are reported in the following Table 4.

TABLE 4
Compressive strengths

| | | | Mortar 1 | | | |
|---|---|---|---|---|---|---|
| | | | (ref.) | Mortar 2 | Mortar 3 | Mortar 4 |
| Compressive | 2 | days | 44 | 32 | 21 | 30 |
| strength | 7 | days | 52 | 46 | 33 | 41 |
| (MPa) | 28 | days | 61 | 54 | 40 | 47 |
| Performance | 2 | days | — | 73 | 48 | 68 |
| index | 2 | days | — | 88 | 63 | 79 |
| (in %) | 28 | days | — | 90 | 65 | 77 |

The mortar according to the invention (mortar 4) has medium and long-term compressive strengths higher than expected and acceptable performances compared to those observed for the reference CEM I (mortar 1) and compatible with the intended uses.

Furthermore, the mortar according to the invention (mortar 4) has short, medium and long-term compressive strengths equivalent to those of mortar 2 (which only comprises 12% of filler) and significantly higher than those of mortar 3 (containing 21% of filler). The addition of calcined marl therefore allows a CEM I substitution rate significantly higher than the substitution rate obtained using the limestone filler alone.

1. A marl for preparation of a pozzolanic material by calcination of the marl at a temperature ranging from 400° C. to 950° C., the marl comprising:
more than 45% (w/w) of calcite; and
at least 1% (w/w) of kaolinite.

2. The marl according to claim 1, comprising at least 50% (w/w) of calcite.

3. The marl according to claim 2, comprising at least 55% (w/w) of calcite.

4. The marl according to claim 1, comprising at least 2% (w/w) of kaolinite.

5. The marl according to claim 4, comprising at least 2.5% (w/w) of kaolinite.

6. The marl according to claim 1, comprising montmorillonite.

7. The marl according to claim 1, comprising illite.

8. The marl according to claim 1, comprising quartz.

9. The marl according to claim 1, comprising chlorite, dolomite, microcline, albite, ankerite, orthoclase, pyrite, siderite, anatase and/or celestine.

10. The marl according to claim 1, wherein the calcination of the marl is carried out at a temperature ranging from 650° C. to 900° C.

11. A process for preparing a pozzolanic material by the calcination of the marl as defined in claim 1 at a temperature ranging from 400° C. to 950° C.

12. The process for preparing a pozzolanic material according to claim 11, the method comprising:
drying and/or crushing the marl to obtain material;
calcinating the obtained material at a temperature ranging from 400° C. to 950° C.; and
disaggregating the obtained calcined marl until reaching a median diameter of 10 μm to 20 μm.
